(19) United States
(12) Patent Application Publication
(10) Pub. No.: US 2020/0293743 A1
(43) Pub. Date: Sep. 17, 2020

(54) PROTECTIVE FILM FOR UNDER-SCREEN ULTRASONIC FINGERPRINT IDENTIFICATION AND PREPARATION METHOD THEREOF

(71) Applicant: Rubiao Zhou, Guangzhou (CN)

(72) Inventor: Rubiao Zhou, Guangzhou (CN)

(21) Appl. No.: 16/521,606

(22) Filed: Jul. 25, 2019

(30) Foreign Application Priority Data
Mar. 15, 2019 (CN) 201910199656.3

(51) Int. Cl. G06K 9/00; B32B 37/12; B32B 7/12

(52) U.S. Cl. CPC G06K 9/00053; G06K 9/0002; B32B 2457/00; B32B 7/12; B32B 37/12

(57) ABSTRACT

A protective film for under-screen ultrasonic fingerprint identification includes a protective layer and a glue layer, and the thickness of the protective film within a fingerprint identification area is ≤0.70 mm. The protective film for under-screen ultrasonic fingerprint identification has low requirements for the shape of the protective layer. As the thickness of the fingerprint identification area is uniform and stable, it is easy to unlock the smartphone, or even achieve a 100% success rate by means of the supporting points.

### CROSS-REFERENCE TO RELATED APPLICATIONS

The present application claims the benefit of Chinese Patent Application No. 201910199656.3 filed on Mar. 15, 2019. The contents of the above are hereby incorporated by reference.

### FIELD OF THE INVENTION

The present invention relates to adhesive materials, and more particular to a protective film for under-screen ultrasonic fingerprint identification and preparation method thereof.

### BACKGROUND OF THE INVENTION

For now, under-screen ultrasonic fingerprint identification technology is increasingly applied to smartphones, which is based on the following principles: ultrasonic waves are capable of penetrating a material; when travelling at the surface of a material, the ultrasonic waves will penetrate the material, be absorbed within it, or be reflected; the reflected ultrasonic waves are also known as echoes; the amount of echoes described before varies depending on the type of material, so it is possible to identify the locations of ridges and valleys of the fingerprint based on the different amount of echoes reflected by the skin and the air, therefore a 3D image of the fingerprint can be constructed. With this method, even dirty fingers can be perfectly identified. However, the ultrasonic fingerprint identification technology is based on radio-frequency technique and requires a certain amount of energy, and there is usually a shortage of energy for penetrating the material. This demands that the protective film shall be thin enough and air-free. On one hand, thin materials such as PET or TPU can easily enable the fingerprint identification, but the anti-scratch and anti-friction properties of materials of these kinds are greatly inferior to glass. On the other hand, glass touches better and has good anti-scratch property, but hot bending glass is easy to warp, so protective films made of curved tempered glass or sapphire glass sold on the market have edges adhered to the screen of a device via double faced adhesive tape, this allows access of air and makes fingerprint identification unavailable.

One type of existing protective film made of hot banding tempered glass is prepared in the following steps: dropping the liquid glue, e.g. UV curing glue or other liquid glue, on a surface of the screen to be protected, overlaying the tempered glass on the liquid glue, and letting the liquid glue level out by the pressure produced by the weight of the tempered glass to form a glue layer in liquid state between the tempered glass and the screen, and solidifying the glue layer by means of UV curing, thermal curing, or whatever. However, the thickness of the glue layer is uneven due to the shape of the tempered glass, movement of the glue and instability of manual operation, which may lead to failure of unlocking the smartphone and cause inconvenience to the users.

To solve this problem, a protective film enabling accurate and sensitive under-screen fingerprint identification is provided in the present invention.

### SUMMARY OF THE INVENTION

To solve the technical problem that the existing tempered glass protective films are unable to achieve accurate and sensitive under-screen fingerprint identification and fail to satisfy the users' need, the present invention provides a protective film enabling accurate and sensitive under-screen fingerprint identification and achieving a 100% success rate.

A protective film for under-screen ultrasonic fingerprint identification comprises a protective layer and a glue layer, and the thickness of the protective film within a fingerprint identification area is ≤0.70 mm.

Preferably, the protective layer is made of hard material available for ultrasonic penetration.

Preferably, the hard material contains glass.

Preferably, the glass is tempered glass.

Preferably, an anti-broken layer is adhesive to either or both of a top surface or a bottom surface of the protective layer.

Preferably, the thickness of the protective layer within the fingerprint identification area is 0.15 to 0.33 mm, the thickness of the anti-broken layer within the fingerprint identification area is 0.025 to 0.075 mm, and the thickness of the glue layer within the fingerprint identification area is 0 to 0.225 mm.

Preferably, the protective layer within the fingerprint identification area is provided with multiple supporting points configured to limit the thickness of the glue layer to within the height of the supporting points, wherein the supporting points have the same height. An object of a certain weight is placed on the supporting points.

Preferably, the height of the supporting points is 0 to 0.225 mm.

Preferably, the supporting points are formed by printing or glue-dropping.

A method of preparing a protective film for under-screen ultrasonic fingerprint identification comprises the following steps.

a) placing the screen in a flat position, and dropping the liquid glue on a surface of the screen;

b) arranging multiple supporting points on the protective layer within the fingerprint identification area, wherein the supporting points are transparent and in liquid state, and solidifying the supporting points into solid state;

c) placing the protective layer on the glue-covered screen with the surface of the protective layer on which the supporting points are arranged facing the screen. The supporting points render a uniform thickness of the glue layer; and

d) placing an object of a certain weight on the protective layer within the fingerprint identification area for a period of time, and then solidifying the liquid glue.

Preferably, the object of a certain weight is a weight.

Preferably, the liquid glue is UV curing glue, light curing glue or heat curing glue, and the curing method is UV curing, light curing or heat curing.

Compared with existing protective films in the art, the present invention has advantages as follows:

As for the protective film for under-screen ultrasonic fingerprint identification provided in the present invention, multiple supporting points are arranged and liquid glue is dropped between the protective layer and the screen within the fingerprint identification area; an object of a certain weight is placed on and applies pressure on the protective layer within the fingerprint identification area; the liquid glue levels out by the pressure described before and then is solidified to form a solid glue layer. The supporting points having the same height render a uniform thickness of the glue layer in a prescribed range and prevent the thickness from being affected by the shape of the protective layer or movement of the liquid glue.

The thickness of the protective film within the fingerprint identification area is uniform and stable, which reduces loss of sonic energy and better allows penetration of ultrasonic waves, thereby increasing the success rate for unlocking the smartphone.

At the same time, the protective film is made of tempered glass, which not only touches better and has good anti-scratch property, but also can better keep the supporting points between the screen and the protective film, so as to keep a uniform thickness of the glue layer.

### BRIEF DESCRIPTION OF THE DRAWINGS

FIG. 1 is a schematic drawing illustrating a protective film according to an embodiment of the present invention;

FIG. 2 is a schematic drawing illustrating the protective film and supporting points arranged therein according to the embodiment of the present invention;

FIG. 3 is a schematic drawing illustrating a fingerprint identification area and the supporting points according to another embodiment of the present invention;

FIG. 4 is another schematic drawing illustrating a fingerprint identification area and the supporting points according to another embodiment of the present invention.

In the figures: 1. protective film, 2. glue layer, 3. screen, 4. anti-broken layer, 5. supporting points, 6. fingerprint identification area.

### DETAILED DESCRIPTION OF ILLUSTRATED EMBODIMENTS

### The First Embodiment

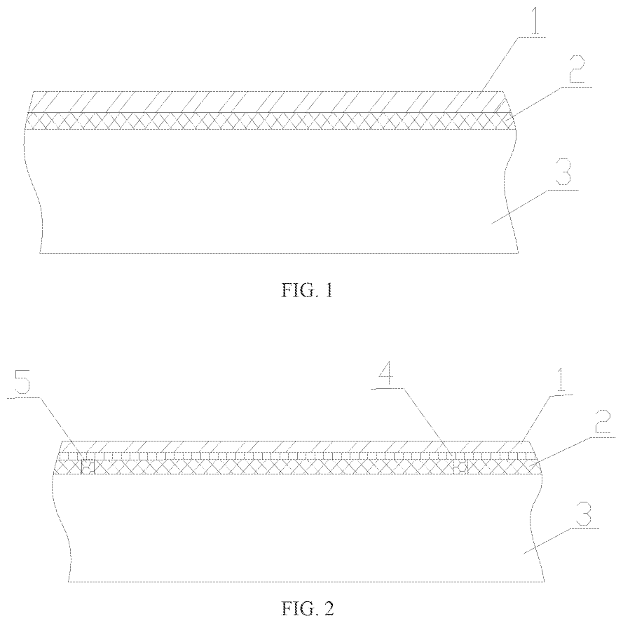

Referring to FIG. 1, a protective film for under-screen ultrasonic fingerprint identification comprises a protective layer 1 and a glue layer 2, wherein the protective layer 1 is made of tempered glass. The thickness of the tempered glass within the fingerprint identification area 6 is 0.20 mm, and the thickness of the glue layer 2 within the fingerprint identification area 6 is 0.01 mm. The protective layer 1 may be made of other hard materials.

A method of preparing a protective film for under-screen ultrasonic fingerprint identification comprises the following steps.

a) placing the screen 3 in a flat position, and dropping the liquid glue on a surface of the screen 3;

b) placing the protective layer 1 on the glue-covered screen 3, and letting the liquid glue level out by the weight of the protective layer 1; and

c) placing an object of a certain weight on the protective layer lwithin the fingerprint identification area 6 for a period of time, and then solidifying the liquid glue.

The prepared protective film is used for under-screen ultrasonic fingerprint identification, and achieves a 100% success rate in fingerprint identification. The object of a certain weight is a weight of 10 g.

### The Second Embodiment

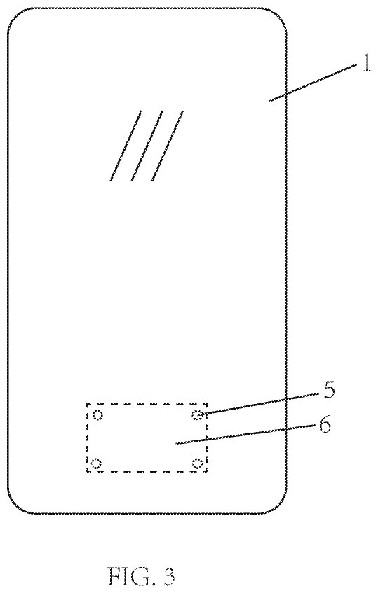

Referring to FIGS. 2 and 3, a protective film for under-screen ultrasonic fingerprint identification comprises a protective layer 1 and a glue layer 2, wherein the protective layer 1 is made of tempered glass. The thickness of the tempered glass within the fingerprint identification area 6 is 0.25 mm.

An anti-broken layer 4 is adhesive to either or both of a top surface or a bottom surface of the protective layer 1 to make the tempered glass safer. The thickness of the anti-broken layer 4 within the fingerprint identification area 6 is 0.025 mm, and the thickness of the glue layer 2 within the fingerprint identification area 6 is 0.10 mm.

Four supporting points 5 are arranged on the protective layer 1 on the boundaries of the fingerprint identification area 6, wherein the height of each supporting point 5 is 0.1 mm. The supporting points 5 are configured to achieve a uniform thickness of 0.10 mm of the glue layer 2 within the fingerprint identification area 6, so as to make the fingerprint identification more accurate and sensitive.

A method of preparing the protective film for under-screen ultrasonic fingerprint identification comprises the following steps.

a) placing the screen 3 in a flat position, and dropping the liquid glue on the surface of the screen 3;

b) arranging four supporting points 5 on the protective layer 1 on the boundaries of the fingerprint identification area 6, wherein the supporting points 5 are transparent and in liquid state, and solidifying the supporting points 5 into solid state;

c) placing the protective layer 1 on the glue-covered screen 3 with the surface of the protective layer lon which the supporting points 5 are arranged facing the screen 3. The supporting points 5 render a uniform thickness of the glue layer 2; and

d) placing a weight of 20 g on the protective layer 1 within the fingerprint identification area 6 for a period of time, and then solidifying the liquid glue.

In this embodiment, with distribution of the four supporting points Sand the pressure of the weight, the thickness of the glue layer 2 within the fingerprint identification area 6 is uniformly 0.01 mm. The prepared protective film used for under-screen ultrasonic fingerprint identification can enable a 100% success rate in fingerprint identification.

### The Third Embodiment

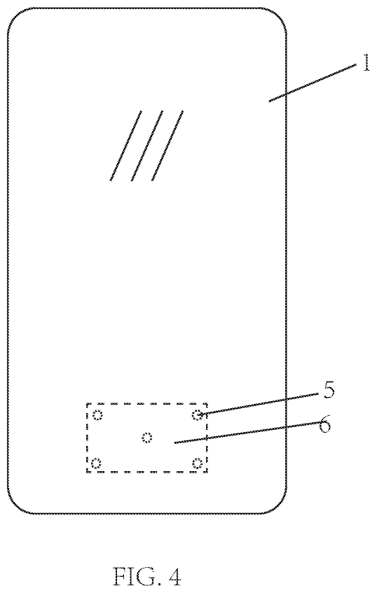

Referring to FIGS. 2 and 4, a protective film for under-screen ultrasonic fingerprint identification comprises a protective layer 1 and a glue layer 2, wherein the protective layer 1 is made of tempered glass. The thickness of the tempered glass within the fingerprint identification area 6 is 0.23 mm.

An anti-broken layer 4 is adhesive to either or both of the top surface or the bottom surface of the protective layer 1 to make the tempered glass safer. The thickness of the anti-broken layer 4 within the fingerprint identification area 6 is 0.05 mm, and the thickness of the glue layer 2 within the fingerprint identification area 6 is 0.15 mm.

Five supporting points 5 are arranged on the protective layer 1 within the fingerprint identification area 6, wherein the height of each supporting point 5 is 0.15 mm. The supporting points 5 are configured to achieve a uniform thickness of 0.15 mm of the glue layer 2 within the fingerprint identification area 6, so as to make the fingerprint identification more accurate and sensitive.

A method of preparing the protective film for under-screen ultrasonic fingerprint identification comprises the following steps.

a) placing the screen 3 in a flat position, and dropping the liquid glue on the surface of the screen 3;

b) arranging five supporting points 5 on the protective layer 1 within the fingerprint identification area 6, wherein the supporting points 5 are transparent and in liquid state, and solidifying the supporting points 5 into solid state;

c) placing the protective layer 1 on the glue-covered screen 3 with the surface of the protective layer 1 on which the supporting points 5 are arranged facing the screen 3. The supporting points 5 render a uniform thickness of the glue layer; and

d) placing a weight of 25 g on the protective layer 1 within the fingerprint identification area 6 for a period of time, and then solidifying the liquid glue.

In this embodiment, with distribution of the five supporting points 5 and the pressure of the weight, thickness of the glue layer 2 within the fingerprint identification area 6 is uniformly 0.15 mm. The prepared protective film used for under-screen ultrasonic fingerprint identification can enable a 100% success rate in fingerprint identification.

It should be understood that although the description is presented in association with embodiments, the specific embodiment does not include only one technical solution. The description is merely for the sake of clarity, and those skilled in the art should regard the specification as a whole. Technical solutions in the embodiments may also be appropriately combined to form other embodiments that can be understood by those skilled in the art.

1. A protective film for under-screen ultrasonic fingerprint identification, which is placed on a screen separated into a fingerprint identification area and other areas, wherein the protective film for under-screen ultrasonic fingerprint identification comprises a protective layer and a glue layer, and the thickness of the protective film within the fingerprint identification area is ≤0.70 mm.

2. The protective film for under-screen ultrasonic fingerprint identification according to claim 1, wherein the protective layer is made of hard material available for ultrasonic penetration, the hard material contains glass, and the glass is tempered glass.

3. The protective film for under-screen ultrasonic fingerprint identification according to claim 2, wherein an anti-broken layer is adhesive to either or both of a top surface or a bottom surface of the protective layer.

4. The protective film for under-screen ultrasonic fingerprint identification according to claim 3, wherein the thickness of the protective layer within the fingerprint identification area is 0.15 to 0.33 mm, the thickness of the anti-broken layer within the fingerprint identification area is 0.025 to 0.075 mm, and the thickness of the glue layer within the fingerprint identification area is 0 to 0.225 mm.

5. The protective film for under-screen ultrasonic fingerprint identification according to claim 1, wherein multiple supporting points are arranged on the protective layer within the fingerprint identification area and inside the glue layer, the supporting points have the same height and are configured to support the protective layer and the screen, and to limit and maintain the thickness of the glue layer.

6. The protective film for under-screen ultrasonic fingerprint identification according to claim 5, wherein the height of the supporting points is 0 to 0.225 mm.

7. The protective film for under-screen ultrasonic fingerprint identification according to claim 5, wherein the supporting points are formed by printing or glue-dropping.

8. A method of preparing the protective film for under-screen ultrasonic fingerprint identification according to claim 1, comprising the following steps:
a) placing the screen in a flat position, and dropping the liquid glue on a surface of the screen;
b) arranging multiple supporting points on the protective layer within the fingerprint identification area, wherein the supporting points are transparent and in liquid state, and solidifying the supporting points into solid state;
c) placing the protective layer on the glue-covered screen with the surface of the protective layer on which the supporting points are arranged facing the screen; the supporting points render a uniform thickness of the glue layer; and
d) placing an object of a certain weight on the protective layer within the fingerprint identification area for a period of time, and then solidifying the liquid glue.

9. A method of preparing the protective film for under-screen ultrasonic fingerprint identification according to claim 2, comprising the following steps:
a) placing the screen in a flat position, and dropping the liquid glue on a surface of the screen;
b) arranging multiple supporting points on the protective layer within the fingerprint identification area, wherein the supporting points are transparent and in liquid state, and solidifying the supporting points into solid state;
c) placing the protective layer on the glue-covered screen with the surface of the protective layer on which the supporting points are arranged facing the screen; the supporting points render a uniform thickness of the glue layer; and
d) placing an object of a certain weight on the protective layer within the fingerprint identification area for a period of time, and then solidifying the liquid glue.

10. A method of preparing the protective film for under-screen ultrasonic fingerprint identification according to claim 3, comprising the following steps:
a) placing the screen in a flat position, and dropping the liquid glue on a surface of the screen;
b) arranging multiple supporting points on the protective layer within the fingerprint identification area, wherein the supporting points are transparent and in liquid state, and solidifying the supporting points into solid state;
c) placing the protective layer on the glue-covered screen with the surface of the protective layer on which the supporting points are arranged facing the screen; the supporting points render a uniform thickness of the glue layer; and
d) placing an object of a certain weight on the protective layer within the fingerprint identification area for a period of time, and then solidifying the liquid glue.

11. A method of preparing the protective film for under-screen ultrasonic fingerprint identification according to claim 4, comprising the following steps:
a) placing the screen in a flat position, and dropping the liquid glue on a surface of the screen;
b) arranging multiple supporting points on the protective layer within the fingerprint identification area, wherein the supporting points are transparent and in liquid state, and solidifying the supporting points into solid state;
c) placing the protective layer on the glue-covered screen with the surface of the protective layer on which the supporting points are arranged facing the screen; the supporting points render a uniform thickness of the glue layer; and
d) placing an object of a certain weight on the protective layer within the fingerprint identification area for a period of time, and then solidifying the liquid glue.

12. A method of preparing the protective film for under-screen ultrasonic fingerprint identification according to claim 5, comprising the following steps:
a) placing the screen in a flat position, and dropping the liquid glue on a surface of the screen;
b) arranging multiple supporting points on the protective layer within the fingerprint identification area, wherein the supporting points are transparent and in liquid state, and solidifying the supporting points into solid state;
c) placing the protective layer on the glue-covered screen with the surface of the protective layer on which the supporting points are arranged facing the screen; the supporting points render a uniform thickness of the glue layer; and
d) placing an object of a certain weight on the protective layer within the fingerprint identification area for a period of time, and then solidifying the liquid glue.

13. A method of preparing the protective film for under-screen ultrasonic fingerprint identification according to claim 6, comprising the following steps:
a) placing the screen in a flat position, and dropping the liquid glue on a surface of the screen;
b) arranging multiple supporting points on the protective layer within the fingerprint identification area, wherein the supporting points are transparent and in liquid state, and solidifying the supporting points into solid state;
c) placing the protective layer on the glue-covered screen with the surface of the protective layer on which the supporting points are arranged facing the screen; the supporting points render a uniform thickness of the glue layer; and
d) placing an object of a certain weight on the protective layer within the fingerprint identification area for a period of time, and then solidifying the liquid glue.

14. A method of preparing the protective film for under-screen ultrasonic fingerprint identification according to claim 7, comprising the following steps:
a) placing the screen in a flat position, and dropping the liquid glue on a surface of the screen;
b) arranging multiple supporting points on the protective layer within the fingerprint identification area, wherein the supporting points are transparent and in liquid state, and solidifying the supporting points into solid state;
c) placing the protective layer on the glue-covered screen with the surface of the protective layer on which the supporting points are arranged facing the screen; the supporting points render a uniform thickness of the glue layer; and
d) placing an object of a certain weight on the protective layer within the fingerprint identification area for a period of time, and then solidifying the liquid glue.

15. The method of preparing the protective film for under-screen ultrasonic fingerprint identification according to claim 8, wherein the liquid glue is UV curing glue, light curing glue or heat curing glue, and the curing method is UV curing, light curing or heat curing.

16. The method of preparing the protective film for under-screen ultrasonic fingerprint identification according to claim 9, wherein the liquid glue is UV curing glue, light curing glue or heat curing glue, and the curing method is UV curing, light curing or heat curing.

17. The method of preparing the protective film for under-screen ultrasonic fingerprint identification according to claim 10, wherein the liquid glue is UV curing glue, light curing glue or heat curing glue, and the curing method is UV curing, light curing or heat curing.

18. The method of preparing the protective film for under-screen ultrasonic fingerprint identification according to claim 11, wherein the liquid glue is UV curing glue, light curing glue or heat curing glue, and the curing method is UV curing, light curing or heat curing.

19. The method of preparing the protective film for under-screen ultrasonic fingerprint identification according to claim 12, wherein the liquid glue is UV curing glue, light curing glue or heat curing glue, and the curing method is UV curing, light curing or heat curing.

20. The method of preparing the protective film for under-screen ultrasonic fingerprint identification according to claim 13, wherein the liquid glue is UV curing glue, light curing glue or heat curing glue, and the curing method is UV curing, light curing or heat curing.

21. The method of preparing the protective film for under-screen ultrasonic fingerprint identification according to claim 14, wherein the liquid glue is UV curing glue, light curing glue or heat curing glue, and the curing method is UV curing, light curing or heat curing.
